(19) United States
(12) Patent Application Publication
(10) Pub. No.: US 2004/0017588 A1
(43) Pub. Date: Jan. 29, 2004

(54) Data transmission apparatus, data transmission method and data transmission program

(75) Inventors: Hironobu Nakata, Itami-Shi (JP); Takeshi Morikawa, Takarazuka-Shi (JP); Kiyoshi Emori, Takatsuki-Shi (JP)

Correspondence Address: BURNS, DOANE, SWECKER & MATHIS, L.L.P., P.O. BOX 1404, Alexandria, VA, 22313-1404, US

(73) Assignee: MINOLTA CO., LTD.

(21) Appl. No.: 10/431,497

(22) Filed: May 8, 2003

Related U.S. Application Data
(60) Provisional application No. 60/407,167, filed on Aug. 30, 2002.

(30) Foreign Application Priority Data
May 10, 2002 (JP) 2002-135796

(51) Int. Cl. H04N 1/00

(52) U.S. Cl. 358/402; 709/245

(57) ABSTRACT

The data transmission apparatus accesses the server using an IP address registered in advance and user information (destination information) is obtained there from. At the same time, group information is sent to the server, and a user name list is obtained from the server based on this information. Only the user names existing on the list are registered in the MFP as destinations from the obtained user name list. As a result, destinations are automatically registered, and only the addresses of persons presumed to use the data transmission apparatus are registered in the apparatus, thereby making the apparatus more convenient to use.

### CROSS-REFERENCE TO RELATED APPLICATIONS

This application is based on application No. 2002-135796 filed in Japan, the contents of which is hereby incorporated by reference.

### BACKGROUND OF THE INVENTION

1. Field of the Invention

The present invention relates to a data transmission apparatus, data transmission method and data transmission program, and more particularly to a data transmission apparatus, data transmission method and data transmission program that can register destinations for a data transmission conducted over a network.

2. Description of the Related Art

In the conventional art, a technology is known by which to register destinations (recipients) for transmission of image data over a network. One specific example of such a technology is a facsimile device that includes a function wherein a destination list is registered and a destination of a transmission is specified from this destination list. In connection with this type of device, various methods whereby destinations are automatically registered in the destination list have been proposed.

For example, in Japanese Patent Laid-Open Application H 11-22415, a technology is disclosed wherein when a facsimile device that sends and receives images in e-mail format receives e-mail data, the sender's address that is included in the received data is automatically registered in the destination list (address book). This type of device makes it less burdensome for the user to register destinations in the destination list.

However, in the facsimile device described above, the problem exists that a destination cannot be automatically registered unless an e-mail is received from another party. As a result, when a user wishes to send image data to another person, he may not be able to easily specify the destination, and may have to specify the destination manually. Furthermore, the problem exists that because when the device is first installed the destination list must be created manually, and where one device is used by multiple persons, because a large number of addresses must be registered in the destination list, a substantial amount of time is required in order to input the names of the other parties, which is burdensome for the administrator.

### OBJECTS AND SUMMARY

The present invention was created in order to resolve the problems described above, and an object thereof is to provide a data transmission apparatus, data transmission method and data transmission program by which destinations for the transmission of data can be easily registered.

In order to attain the above object, a first aspect of the present invention is a data transmission apparatus that can specify a registered address and transmit data to the specified address over a network, wherein this data transmission apparatus includes a memory which stores a server IP address in advance, a transmitting unit which accesses a server based on the server IP address stored in the memory and transmits to the server a command requesting user information including destination information, a receiving unit which receives the user information sent from the server in response to the request command; and a controller which registers destination information included in the received user information as the destination for data transmission.

A second aspect of the present invention is a data transmission method whereby a registered address is specified and data is sent to this destination over a network, wherein such method includes the steps of: accessing a server based on its IP address stored in advance; transmitting to the server a command requesting user information including destination information; receiving the user information sent from the server in response to the request command; registering as a data transmission destination the destination information included in the received user information; and specifying a registered destination and sending data to that destination.

A third aspect of the present invention is a data transmission program that causes a data transmission apparatus to execute the steps of: accessing a server based on its IP address stored in advance; transmitting to the server a command requesting user information including destination information; receiving the user information sent from the server in response to the request command; registering as a data transmission destination the destination information included in the received user information; and sending data over the network to the destination specified from among the registered destinations.

These and other objects, advantages and features of the invention will become apparent from the following description thereof taken in conjunction with the accompanying drawings which illustrate specific embodiments of the invention.

### BRIEF DESCRIPTION OF THE DRAWINGS

FIG. 1 shows a data transmitting/receiving system pertaining to one embodiment of the present invention;

FIG. 2 is an external view of an MFP 1;

FIG. 3 is a block diagram showing those parts of the MFP 1 that principally pertain to this embodiment;

FIG. 4 shows the functions realized by the CPU 20 operating in accordance with the program 221 residing in the ROM 22, together with other constituent functions;

FIG. 5 is a block diagram showing the construction of a personal computer or server;

FIG. 6 is a flow chart showing a routine executed by the CPU 20 of the MFP 1;

FIG. 7 shows a specific example of a user information table stored on the server;

FIG. 8 shows a specific example of a user name list corresponding to a group name;

FIG. 9 shows destinations displayed on the operation panel of the MFP 1;

FIG. 10 is a flow chart showing a routine executed by the CPU of the server 200;

FIG. 11 shows a variation of the flow chart shown in FIG. 6;

FIG. 12 shows a specific example of a user information table stored on the server; and

FIG. 13 shows a specific example of a user name list corresponding to a group name.

In the following description, like parts are designated by like reference numbers throughout the several drawings.

### DESCRIPTION OF THE PREFERRED EMBODIMENTS

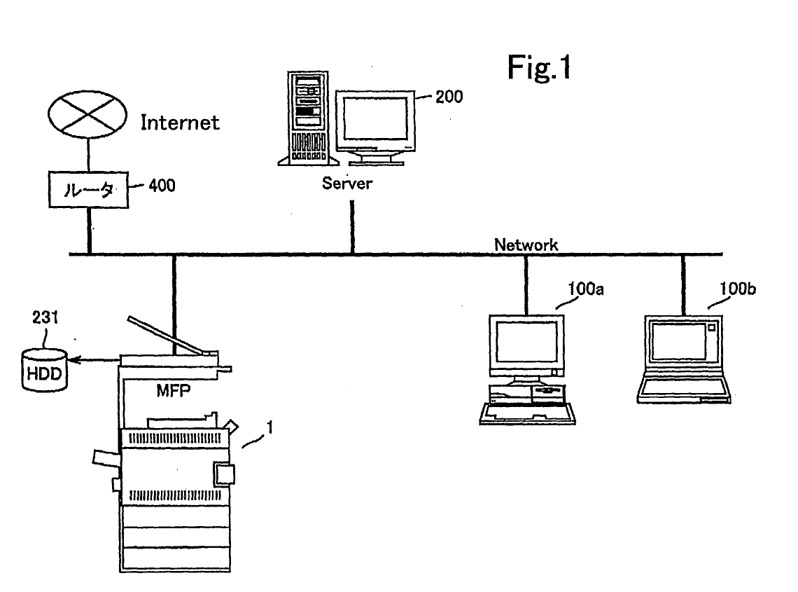

FIG. 1 shows the construction of a data transmitting/receiving system pertaining to one embodiment of the present invention.

With reference to the drawing, the data transmitting/receiving system comprises an MFP (multi-functional peripheral) 1 that serves as a data transmission apparatus connected to a LAN, personal computers (PC's) 100a and 100b that serve as data receiving apparatus, a router 400 that enables connection to the Internet, and a server 200.

A hard disk drive (HDD) 231 is connected (or built into) the MFP 1, and image data read by the scanner of the MFP 1 is stored on the hard disk drive 231 for later use.

Multiple user boxes (folders) are prepared in advance on the hard disk drive 231 for users, i.e., one box per user, and a user stores read image data in his own user box by specifying such user box. By operating his own personal computer, the user can extract image data from his user box and move it to a folder on his personal computer.

Furthermore, by specifying an e-mail account, address or the like, the user can send data in e-mail format to a destination (either a machine connected to the LAN or a machine connected over a network to the Internet or the like) corresponding to such account or address.

While FIG. 1 shows an example in which only one MFP 1 is connected to the network, multiple MFPs may be connected to the network. Furthermore, unique identification information (i.e., an IP address) that specifies each device on the network is allocated to each such device, enabling devices on the network to identify each other.

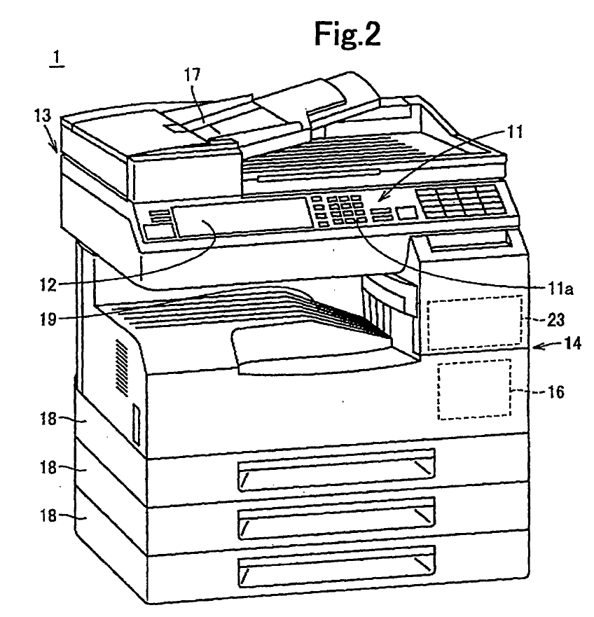

FIG. 2 is an external view of the MFP 1 shown in FIG. 1. The MFP 1 is a multifunction device that has the functions of a scanner, copier, printer, facsimile machine and the like, and can send and receive data over a network.

The MFP 1 includes multiple keys 11a as shown in FIG. 2, and further includes an operation unit 11 that receives input of various instructions, as well as of data comprising numbers and letters, via the user's operation of these keys, a display 12 that displays such information as instruction menus for the user and information regarding obtained images, a scanner unit 13 that obtains image data via the optical reading of an original document, and a printer unit 14 that prints images on a recording sheet based on image data.

In addition, a feeder unit 17 that sends original documents to the scanner unit 13, is disposed on the top of the MFP 1 main unit, a paper supply unit 18 that supplies recording sheets to the printer unit 14 is disposed at the bottom of the MFP 1, a tray 19 onto which recording sheets on which images have been printed by the printer unit 14 are ejected is disposed at the center of the MFP 1, and a transmission unit 16 that sends and receives image data to and from external devices over a network, as well as a storage unit 23 that stores image data and other data, are disposed inside the MFP 1. Furthermore, while not shown in the drawings, the MFP 1 has a network interface, and the transmission unit 16 is connected to the network via this network interface such that various types of data can be sent and received between the transmission unit 16 and external devices.

The display 12 is used for display of various information, including display of a list of various data transmission destinations (recipients). The operation unit 11 is used for various types of input, including selection of a destination by the user. These components function as key elements of the user interface.

The scanner unit 13 obtains image data via optical reading of image information such as photographs, characters or drawings from an original document. The obtained image data (density data) is converted into digital data by an image processor not shown, and after various public-domain image processing is carried out with respect to the data, it is sent to the printer unit 14 or the transmission unit 16 for image printing or data transmission, or else the data is stored in the storage unit 23 for later use.

The printer unit 14 prints images onto recording sheets based on image data obtained from the scanner unit 13, image data received from an external device via the transmission unit 16, or image data stored in the storage unit 23.

In addition to sending and receiving facsimile data via public telephone circuits, the transmission unit 16 sends and receives data to and from an external device connected to a network such as the Internet or a LAN in e-mail format over such network. Accordingly, the MFP 1 functions not only as a facsimile device that performs conventional facsimile transmission, but also as a terminal for the sending and receiving of e-mail. Therefore, various types of image data can be sent and received as attachments to e-mail. The network transmission conducted by the MFP 1 can be wired or wireless. The example shown indicates a transmission method using ground wires.

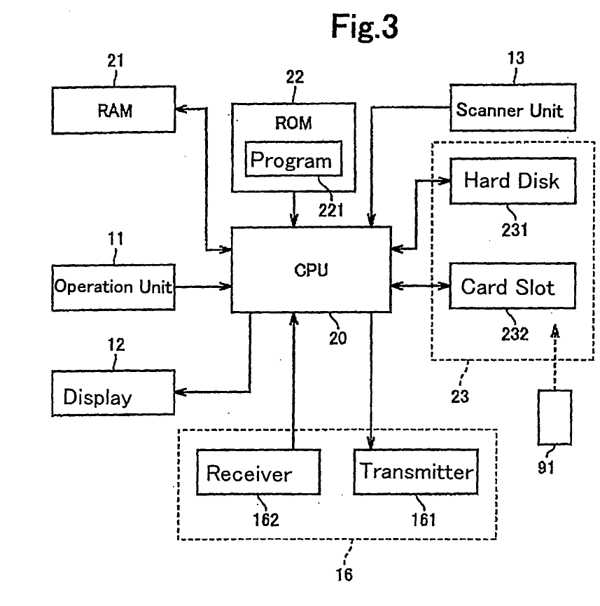

FIG. 3 is a block diagram mainly showing the parts of the MFP 1 that pertain to this embodiment. The MFP 1 includes a CPU 20 that carries out various calculation routines, and controls the overall operation of the MFP 1. A RAM 21 that stores various types of data and a ROM 22 that stores a program 221 are connected to the CPU 20. In addition, an operation unit 11, a display 12, a scanner unit 13 and a storage unit 23 are connected to the CPU 20. The storage unit 23 comprises a hard disk 231 that stores image and other data, as well as a card slot 232 that reads information from a memory card 91. The RAM 21 is a nonvolatile RAM.

Using this construction, various types of data can be transmitted and received between the RAM 21, the scanner unit 13, the hard disk 231 and the memory card 91 mounted in the card slot 232 under the control by the CPU 20, and information stored in the RAM 21, the hard disk 231 or the memory card 91 can be displayed on the display 12 via the control by the CPU 20.

In addition, a transmission unit 16 that includes a transmitter 161 and a receiver 162, and which carries out transmission and receipt of data to and from external devices connected via the network, is connected to the CPU 20.

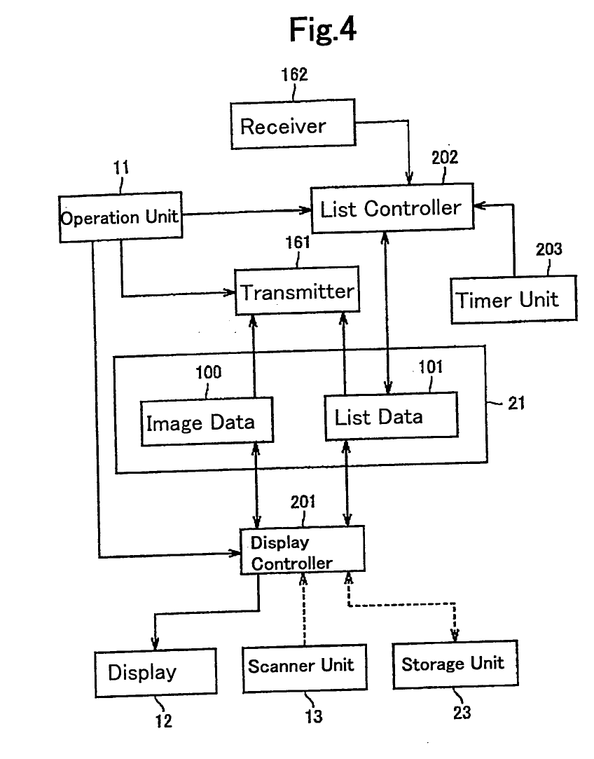

FIG. 4 shows the functions realized by the CPU 20 operating in accordance with the program 221 residing in the ROM 22, together with other constituent functions. Among the functions shown in FIG. 4, the display controller 201, the list controller 202 and the timer unit 203 are the functions implemented by the CPU 20.

The display controller 201 obtains image data 100 from the scanner unit 13 or the storage unit 23, forwards it to the RAM 21, or stores the image data 100 stored in the RAM 21 in the storage unit 23, as well as executes routines necessary with regard to list data 101 described below and displays on the display 12 a list of destinations.

The list controller 202 creates list data 101 in which destinations of data to be transmitted are automatically registered based on sender information included in the notification received by the receiver 162. For example, where an e-mail containing attached image data is sent from a certain user's PC, that e-mail address is automatically registered as a destination. In addition, the list controller 202 has a function whereby, based on a signal from the timer unit 203 that measures the time elapsed since the notification was received by the receiver 162, it is determined whether or not the destination registered in the list data 101 is a destination that is available for data transmission to update the list data 101.

The transmitter 161 obtains from the list data 101 the address of the destination selected via user operation of the keys 11a on the operation unit 11, with reference to the list of destinations on the display 12, and transmits image data 100 to that address.

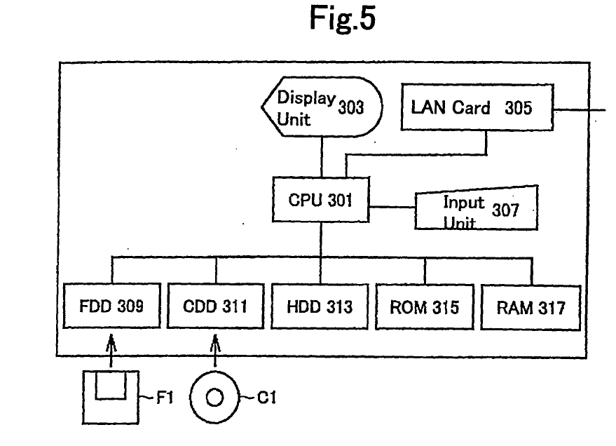

FIG. 5 is a block diagram showing the hardware construction of a personal computer or server.

With reference to the drawing, the personal computer or server includes a CPU 301 that controls the entire apparatus, a display unit 303, a LAN card 305 used for connecting the computer or server to a LAN, an input unit 307 comprises a keyboard and a mouse or the like, a flexible disk drive 309, a CD-ROM drive 311, a hard disk drive 313, a ROM 315 and a RAM 317.

Image data, a program or other data stored on a flexible disk (F1) can be read by the flexible disk drive 309, and image data, a program or other data stored on a CD-ROM (C1) can be read by the CD-ROM drive 311.

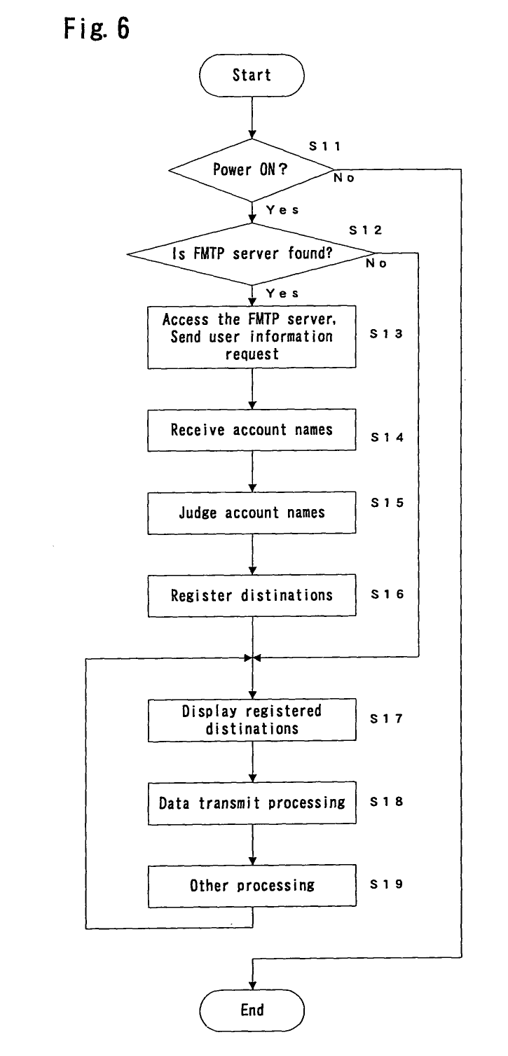

FIG. 6 is a flow chart showing a routine executed by the CPU 20 of the MFP 1 connected to the network. This routine is executed based on a program 221 stored in the ROM 22.

Information indicating the IP address of the server 200 and destination group to be registered is stored in advance in the RAM 21 of the MFP 1. This information is freely set by a service technician or an operator when the apparatus is installed or when it is serviced. A destination group is a collection of multiple user addresses assembled according to prescribed criteria (such as department, workplace, period of use).

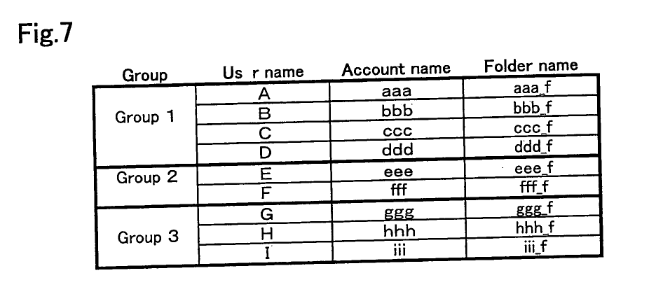

FIG. 7 is a table of user information stored in the RAM 317 of the server 200. Here, user information is stored in association with such categories as user name, account name and folder name for three groups. The user information in this table is updated as needed by the administrator.

Here, the MFP 1 obtains an e-mail address by accessing a server based on its registered IP address.

With reference to FIG. 6, it is determined in step S11 whether or not power to the MFP 1 has been turned ON, and if the result of the determination is YES, a search for the SMTP server is carried out in step S12, while if the result is NO, the routine ends.

In step S12, the network is searched using the SMTP server's IP address, which was registered in advance in the format of, for example, ‘140.18.127.2’. If the server is found (YES in step S12), the CPU 20 advances to step S13. In step S13, the SMTP server is accessed according to a prescribed protocol. This prescribed protocol may be a unique protocol or may be a general-purpose protocol such as SMTP (Simple Mail Transfer Protocol). In step S13, a command requesting user information (destination information) is sent to the server. The command requesting user information includes information indicating the destination group stored in advance in the RAM 21, and corresponds to the prescribed protocol. It is assumed here, as one example, that information indicating Group 1 is included.

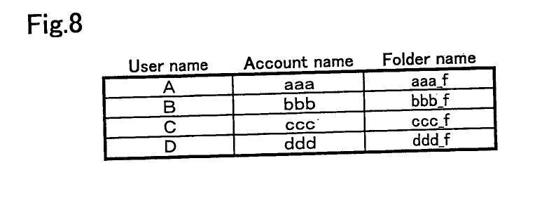

Next, in step S14, in response to the command requesting user information transmitted in step S13, the user information (username list) corresponding to that group (here, Group 1 ) is obtained from the server. The obtained list is then stored in the RAM 21, as shown in FIG. 8.

With reference to FIG. 8, a user name, account name and folder name are stored in the list for each user.

The ‘account name’ referred to here is the ‘aaa’ part of the e-mail address ‘aaa@bbb.co.jp’. In this embodiment, because destinations managed by a common domain are handled as registered destinations, the ‘@bbb.co.jp’ part of the e-mail address is fixed. Therefore, in this construction, the destination e-mail address is set automatically based on the account name information. Furthermore, if the e-mail address itself is recorded as well as the account name, this system may be applied to destinations having a different domain name. The folder name is the name of the folder in which data is stored at the destination, i.e., the name of the folder in which transmission data is stored.

In step S15, it is determined whether or not the list obtained in step S14 includes user information that has already been registered. From the user information contained in the obtained list, user information that has not been registered is then extracted. In other words, from among the account names in the list shown in FIG. 8, the account names that do not match the account names in the list data 101 are extracted. The extracted user information is registered as destination list information in the list data 101 in step S16.

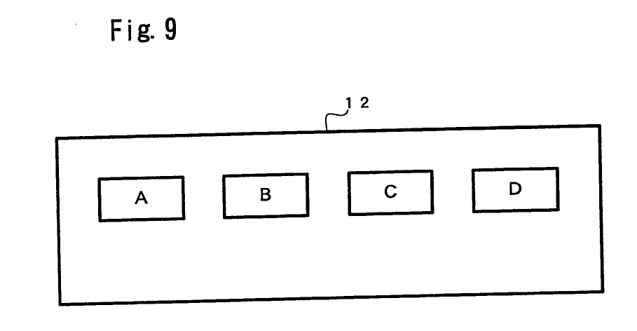

In step S17, the destinations (user names) are displayed on the display 12 of the MFP 1, as shown in FIG. 9. The user selects the desired destination from among the displayed destinations, and in step S18, processing to transmit the image data to the selected destination is executed.

As described above, in this embodiment, the user name list corresponding to the group name is obtained, it is determined whether or not the user information (destination information) for each name on the user name list is already registered in the MFP 1, and only accounts that are determined to be not already registered are registered in the MFP 1 as destinations. As a result, because all destinations in a group that are registered in the MFP 1 are automatically registered, the burden on the user of registering destinations can be reduced. Moreover, because only accounts that exist in the user name list are registered as destinations in the MFP 1, the registration of accounts that are of no interest to the user can be prevented.

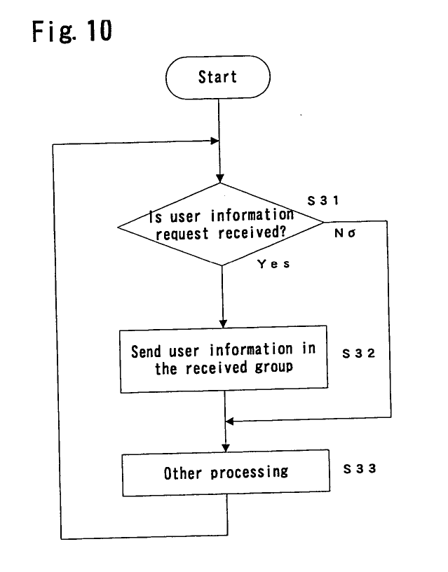

FIG. 10 is a flow chart showing a routine executed by the CPU 301 of the server 200.

In step S31, it is determined whether or not a command requesting user information has been received from the MFP 1. If the result of this determination is YES, information regarding the users belonging to the group is read from the table in the RAM 317 based on the destination group information included in the received command, and is then sent to the MFP 1 as a user name list (S32).

In step S33, other routines are executed on the server 200.

[Variation]

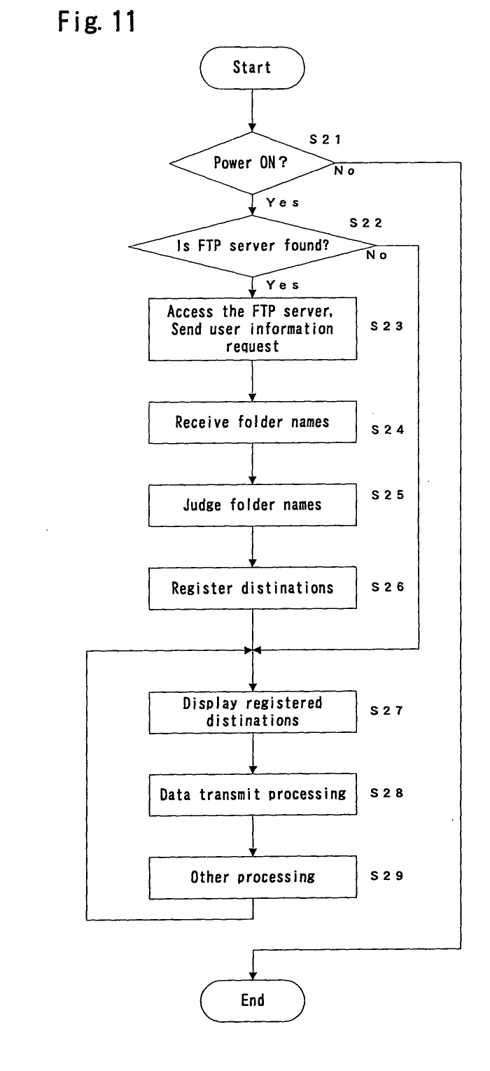

FIG. 11 is a flow chart showing a variation of the flow chart shown in FIG. 6. In this variation, an example is shown in which an FTP server is used as the server. Here, the folder in which sent data is stored is obtained as user information (destination information).

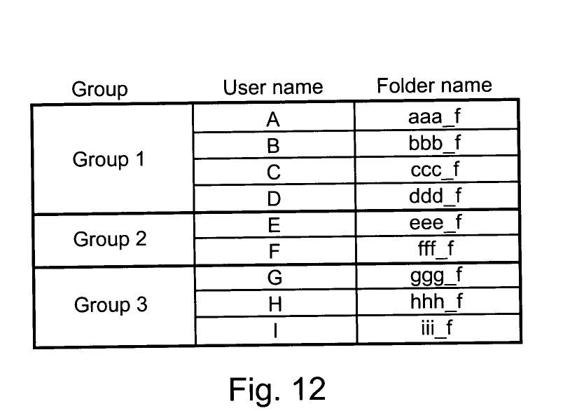

In addition, in this variation, a user information table as shown in FIG. 12 is stored on the FTP server. Here, user information is stored in association with such categories as user name and folder name for three groups.

With reference to FIG. 11, in step S21, it is determined whether or not power to the MFP 1 has been turned ON, and if the result of this determination is YES, a search for the FTP server is executed in step S22, while if the result is NO, the routine ends.

In step S22, the network is searched using the FTP server's IP address, which was registered in advance in the MFP 1. If the server is found (YES in step S22), the CPU 20 advances to step S23. In step S23, the FTP server is accessed according to a prescribed protocol. In step S23, a command requesting user information (destination information) is sent to the server. The command requesting user information includes information indicating the destination group stored in advance in the RAM 21, and corresponds to the prescribed protocol. It is assumed here, as one example, that information indicating Group 1 is included.

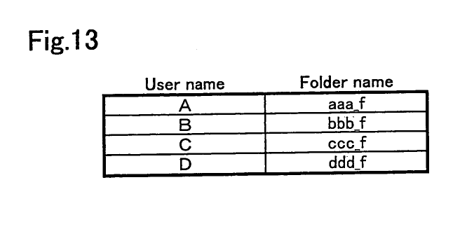

Next, in step S24, in response to the command requesting user information transmitted in step S23, the user information (user name list) corresponding to that group (here, Group 1 ) is obtained from the server. The obtained list is then stored in the RAM 21, as shown in FIG. 13.

In step S25, it is determined whether or not the list obtained in step S24 includes user information that has already been registered. From the user information contained in the obtained list, user information that has not been registered is then extracted. In other words, from among the folder names in the list shown in FIG. 13, the folder names that do not match the folder names in the list data 101 are extracted. The extracted user information is registered as destination list information in the list data 101 in step S26.

According to this embodiment, the MFP 1 accesses the server using an IP address registered in advance and user information (destination information) is obtained there from. At the same time, group information is sent to the server, and a user name list is obtained from the server based on this information. Only the user names existing on the list are registered in the MFP as destinations from the obtained user name list. As a result, destinations are automatically registered, and only the addresses of persons presumed to use the MFP are registered in the MFP, thereby making the MFP more convenient to use.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A data transmission apparatus that can specify a registered address and transmit data to the specified address over a network, the data transmission apparatus comprising:
a memory which stores a server IP address in advance;
a transmitting unit which accesses a server based on the server IP address stored in the memory and transmits to the server a command requesting user information including destination information;
a receiving unit which receives the user information sent from the server in response to the request command; and
a controller which registers destination information included in the received user information as the destination for data transmission.

2. A data transmission apparatus as claimed in claim 1,
wherein said controller determines whether or not the destination included in the received user information has already been registered in its own apparatus, and registers only destinations that have not already been registered.

3. A data transmission apparatus as claimed in claim 1,
wherein said request command includes a group information, and the receiving unit receives from the server information regarding the multiple users belonging to the group.

4. A data transmission apparatus as claimed in claim 1,
wherein said destination information includes one or both of the account name and the folder name.

5. A data transmission apparatus as claimed in claim 1,
wherein said transmitting unit accesses the server when power is started to the apparatus.

6. A data transmission apparatus as claimed in claim 1, further comprising:
a display which displays the registered destinations.

7. A data transmission apparatus as claimed in claim 6, further comprising:
a data transmission unit which transmits data over a network to a destination selected from the displayed destinations.

8. A data transmission method whereby a registered address is specified and data is sent to the destination over a network, the method comprising the steps of:
accessing a server based on its IP address stored in advance;
transmitting to the server a command requesting user information including destination information;
receiving the user information sent from the server in response to the request command;
registering as a data transmission destination the destination information included in the received user information; and
specifying a registered destination and sending data to that destination.

9. A data transmission method as claimed in claim 8,
wherein said registering step determines whether or not the destination included in the received user information has already been registered in its own apparatus, and registers only destinations that have not already been registered.

10. A data transmission method as claimed in claim 8,
wherein said request command includes a group information, and the receiving step receives from the server information regarding the multiple users belonging to the group.

11. A data transmission method as claimed in claim 8,
wherein said destination information includes one or both of the account name and the folder name.

12. A data transmission method as claimed in claim 8,
wherein said accessing step accesses the server when power is started to the apparatus.

13. A data transmission method as claimed in claim 8, further comprising the step of:
displaying the registered destinations.

14. A data transmission program that causes a data transmission apparatus to execute the steps of:
accessing a server based on its IP address stored in advance;
transmitting to the server a command requesting user information including destination information;
receiving the user information sent from the server in response to the request command;
registering as a data transmission destination the destination information included in the received user information; and
sending data over the network to the destination specified from among the registered destinations.
